(19) United States
(12) Patent Application Publication
(10) Pub. No.: US 2009/0206511 A1
(43) Pub. Date: Aug. 20, 2009

(54) PRECIPITATED SILICA REINFORCED EPDM RUBBER FORMULATION MANUFACTURING PROCESS, PROCESS FOR THE OBTAINMENT OF A REINFORCED RUBBER PROFILE, COLORED EXTRUDED RUBBER PROFILE AND ITS USE

(76) Inventors: Ana Antonia De Paiva, Campinas (BR); Paulo Roberto Garbelotto, Campinas (BR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/912,063

(22) PCT Filed: Apr. 20, 2006
(86) PCT No.: PCT/BR2006/000081

§ 371 Date: Jan. 6, 2009

(30) Foreign Application Priority Data
Apr. 20, 2005 (BR) PI0501490-5

(51) Int. Cl. C08K 5/09; C08K 3/34; C08K 3/26; C08K 3/22; B29C 47/88

(52) U.S. Cl. 264/211.12; 524/322; 524/447; 524/426; 524/432

(57) ABSTRACT

The high dissipating precipitated silica reinforced EPDM rubber (monomer of ethylene-propylene-diene) and a colored extruded polymeric profile including the formulation, are particularly intended for use in the building and automobile industry. The process for the manufacturing the formulation for reinforced EPDM rubber, includes the use of one or more EPDM polymers, at least one high dissipating precipitated silica as a reinforcing filler, a non-reinforcing filler, an antioxidant, an interface agent and/or coupling agent, a desiccant, an accelerating activator, and vulcanization additives.

### FIELD OF THE INVENTION

The present invention refers to a high dissipating precipitated silica reinforced EPDM (monomer of ethylene-propylene-diene) rubber formulation and a colored extruded polymeric profile comprising the formulation, particularly intended for using in the building and automobile industry. The invention also refers to a manufacturing process of the formulation.

### BACKGROUND OF THE INVENTION

It is known that several kinds of polymers for production of profiles, such as polyvinyl chloride (PVC), monomer of ethylene-propylene-diene (EPDM) and silicone rubber, are specifically useful for the building and automobile industry.

French patent FR 0.272.361 discloses a process for the manufacturing of a PVC article, particularly with the addition of EPDM. PVC profiles present a relatively low cost, but however, have inferior mechanical properties, more particularly low resistance to intemperate weather.

EPDM is a material that presents excellent resistance to intemperate weather, to ozone and to temperatures variations. EPDM has a performance that may be superior to PVC (polyvinyl chloride), SBR (Copolymer of Butadiene and Styrene) and others, which are less compatible to continuous thermal changes. EPDMs are amorphous polymers except for high ethylene grades that develop crystallization in the drawing, and consequently, they are desirably reinforced to achieve better properties.

U.S. Pat. No. 6,279,633 discloses a composition of precipitated silica reinforced EPDM rubber (with superficial area of about 110 to 130 m²/g) mixed with organosilane disulfide, optionally using black carbon in its composition. The use of silica as a reinforcing filler in formulations for rubber article formulations has been a good market alternative due to it is possibility to substitute black carbon by introducing a new option of coloring in rubber profiles with similar characteristics, since black carbon reinforcing filler is limited to the black color.

Recently, the company Rhodia has developed a silicone rubber profile (Rhodiastic®) that is highly hydrophobic and self-regenerative, having superior resistance under severe and demanding conditions of assembly and usage, climate and pollution. This profile may be colored, presenting excellent electrical and mechanical properties, however it has a cost related to market premium sectors.

In view of previous technology, it was desired to develop a colored profile improved with mechanical properties similar to the ones obtained with black carbon, presenting resistance to intemperate weather, but with a lower cost in relation to a silicone rubber profile, as developed by the Applicant.

### SUMMARY OF THE INVENTION

Features of the present invention refer to an improved reinforced EPDM rubber formulation with high dissipating precipitated silica in the manufacture of colored profiles and with suitable mechanical properties.

The present invention refers, as a first object, to a formulation for reinforced EPDM rubber, wherein it comprises:

(a) one or more EPDM polymers;

(b) at least one high dissipating precipitated silica as a reinforcing filler;

(c) a non-reinforcing filler;

(d) an antioxidant;

(e) an interface agent and/or coupling agent;

(f) a desiccant;

(g) an accelerating activator; and

(h) vulcanization additives.

### DETAILED DESCRIPTION OF THE INVENTION

The formulation of the invention provides colored profiles highly resistant to intemperate weather, being characterized by having in its EPDM rubber formulation a high dissipating precipitated silica (HDS prepared silica) that presents as an important physic-chemical characteristic over a low superficial area, between about 30 to 100 m²/g, particularly of about 50 m²/g. As to the amount of precipitated silica, the formulation comprises about 50 to 250 phr (parts by one hundred of rubber), particularly about 100 to 200 phr and, more specifically, about 150 to 175 phr. The precipitated silica namely, high dispersible silica (HDS) has up to 8% of water content.

The concept of high dispersibility is easily illustrated by the ultrasonic disruption test, where the ability of a silica to be broken into small objects after applying a given ultrasonic energy during a given time is measured. The size of final objects (granulometric repartition) is measured with a laser granulometer. Through this test, HDS typically shows D50 values around 2.8 μm and the occurrence of very small objects below 1 μm. On the contrary, large objects (e.g. >20 μm with this specific test) are almost inexistent.

The concentration of EPDM in the formulation of the invention may vary according to mechanical and structural properties desired for the final product, as a person skilled in the art knows to determine it. Particularly, the proportion of one or more polymers of EPDM used in the present invention is of 100 phr. Polymers of EPDM useful in the present invention preferably present (without excluding any alternatives) contents of about 0.1 to 15% of double coupling in their structural formula, a useful characteristic to control the vulcanization process.

The use of non-reinforcing filler in the formulation of the present invention, as calcinated clay, provides a better aspect for an EPDM profile. Interface agents, such as polyethylene glycol (PEG) or triethanolamine (TEA) improve the compatibility between HDS precipitated silica and the EPDM polymer. According to the present invention, the interface agents may vary in amounts of about 0 to 10 phr, particularly from about 3 to 6 phr. In case of PEG, preferably from about 4 to 4.5 phr. In case of TEA, from about 0.5 to 5 phr, particularly from 1 to 4 phr, preferably about 1.5 to 3 phr.

Coupling agents, such as organosilane, proportionate compatibility between silica and the polymer, generate compounds with good mechanical properties. The amount of coupling agent in the present invention may vary from about 0 to 11 phr, particularly from about 3 to 9 phr, preferably about 7.5 to 8.5 phr. The amounts of interface and coupling agents are significantly proportional to the amount of silica used in the present invention.

The formulation of the present invention still uses a desiccant, for instance calcium oxide (CaO), in an amount particularly from about 5 to 50 phr, more particularly from about 8 to 30 phr and even more particularly from about 22 to 26 phr. The presence of high dissipating precipitated silica in the present formulation suggests the use of superior amounts of the desiccant with the property of reducing the humidity rate.

One of the accelerating activators used in the present invention is zinc oxide employed in high concentration, for instance, between about 15 and 30 phr, particularly about 25 phr. Other components, such as antioxidant, process oil, stearic acid, vulcanization accelerators, sulphur, and chemically acceptable excipients are employed in the formulation of the present invention according to practices known in the art.

One excipient specific for the formulation of the present invention is one or more pigments to provide color to the mass obtained by the process mentioned below. Without any limitation, some of the pigments suitable are: titanium dioxide, iron oxide, black carbon, or organic pigments. Process oil useful to the formulation acts in the process and in the final properties of the product. An example of process oil is paraffinic oil.

Comparative examples of formulations having known black carbon NF550 and HDS precipitated silica (exemplified in the case by silica ZS40, sold by Rhodia Brasil Ltda) are described below. These examples show that by substituting black carbon by HDS silica in a formulation is necessary to make some changes in the formulation so that the rheologic, rheometric and mechanic properties are similar: to use more accelerators, or to adjust the vulcanization system; to adjust the dose of oil process and to include interface agents and/or coupling agents.

### EXAMPLES

### Example I

| | Carbon Black | Silica ZS40 |
|---|---|---|
| Ingredients | 550 (phr) | (phr) |
| EPDM | 100 | 100 |
| (Nordel IP 5565, sold by DuPont Dow | | |
| Elastomers) | | |
| Antioxidant | 1 | 1 |
| Carbon Black 550 | 150 | — |
| Silica ZS40 (sold by Rhodia Brasil | — | 120 |
| Ltda) | | |
| Zeosil 175 (sold by Rhodia Brasil | — | 30 |
| Ltda) | | |
| Calcined kaolin | 10 | 10 |
| PEG 4000 | — | 4.0 |
| TEA | — | 1.5 |
| Organosilane | — | 7.5 |
| (HP 669, sold by Hung Pai Chemistry | | |
| Co Ltda) | | |
| Flow agent | 3.0 | 3.0 |
| (Struktol WB 16, sold by Struktol | | |
| Comp. of America) | | |
| Paraffinic oil | 100 | 70 |
| (Flexpar 848, sold by Ipiranga | | |
| Química) | | |
| Estearic acid | 2 | 2 |
| Zinc oxide | 10 | 25 |
| PE wax | 3 | — |
| (Proquiwax, sold by PROQUITEC | | |
| Indústria de Produtos Químicos Ltda, | | |
| Brasil) | | |
| Calcium oxide | 8 | 26 |
| Sulphur | 2.3 | 2.3 |
| MBTS ⁽¹⁾ (2-2′ dithiobis | 2.0 | 2.0 |
| (benzothiazole)) | | |
| TMTD ⁽²⁾ (tetramethylthiuram | 1.0 | 1.0 |
| disulfide) | | |
| ZDBC ⁽³⁾ (dibuthyldithiocarbamate | 1.5 | 1.5 |
| zinc) | | |
| ZDMC ⁽⁴⁾ (n-dimethyldithiocarbamate | 1.5 | 1.5 |
| zinc) | | |

⁽¹⁾ Perkacit MBTS, sold by Flexsys;
⁽²⁾ Perkacit TMTD, sold by Flexsys;
⁽³⁾ Perkacit ZDBC, sold by Flexsys;
⁽⁴⁾ Perkacit ZDMC, sold by Plexsys;

### Example II

| | Carbon Black | Silica ZS40 |
|---|---|---|
| Ingredients | 550 (phr) | (phr) |
| EPDM | 100 | 100 |
| (Nordel IP 5565, sold by DuPont Dow | | |
| Elastomers) | | |
| Antioxidant | 1 | 1 |
| Carbon Black 550 | 175 | — |
| Silica ZS40 (sold by Rhodia Brasil | — | 145 |
| Ltda) | | |
| Zeosil 175 Plus (sold by Rhodia | — | 30 |
| Brasil Ltda) | | |
| Calcined kaolin | 33 | 33 |
| PEG 4000 | — | 4.2 |
| TEA | — | 3.0 |
| Organosilane | — | 8.8 |
| (HP 669, sold by Hung Pai Chemistry | | |
| Co. Ltd.) | | |
| Flow agent | 3.5 | 3.5 |
| (Struktol WB 16, sold by Struktol | | |
| Comp. of America) | | |
| Paraffinic oil | 120 | 120 |
| (Flexpar 848, sold by Ipiranga | | |
| Química) | | |
| Estearic acid | 2 | 2 |
| Zinc oxide | 10 | 25 |
| PE Wax | 3 | — |
| (Proquiwax, sold by PROQUITEC | | |
| Indústria de Produtos Químicos Ltda, | | |
| Brasil) | | |
| Calcium oxide | 8 | 26 |
| Sulphur | 2.0 | 2.0 |
| MBT ⁽⁵⁾ (2-mercaptobenzothiazole) | 1.3 | 1.3 |
| TMTM ⁽⁶⁾ (tetramethyltiuram | 1.5 | 1.5 |
| monosulfide) | | |
| ZDBC | 3.0 | 3.0 |
| ZDMC | 1.8 | 1.8 |
| DTDM ⁽⁷⁾ (4,4′dithiodimorpholine) | 1.2 | 1.2 |

⁽⁵⁾ Perkacit MBT, sold by Plexsys;
⁽⁶⁾ Perkacit TMTM, sold by Plexsys;
⁽⁷⁾ Perkacit DTDM, sold by Plexsys;

COMPARATIVE TABLE OF THE RHEOMETRIC,
RHEOLOGIC AND MECHANICAL PROPERTIES

| | Black Carbon | ZS40 |
|---|---|---|
| Torque | 550 | (invention) |

Rheometric Properties
Torque Rheometer ODR R100 at 185° C. according to rule
ASTM D2084

| | | |
|---|---|---|
| M_{L} (lb. pol) | 9 | 5 |
| M_{H} (lb. pol) | 54 | 50 |
| Tₛ2 (min:sec) | 00:42 | 00:42 |
| t′90 (min:sec) | 02:00 | 04:00 |

Rheologic Properties
Torque Viscometer Mooney ML at 100° C. according to rule
ATSM D1646

| | | |
|---|---|---|
| ML 1 + 4 | 62 | 70 |

Mechanical Properties
Vulcanization: t′90 at 185° C.; before maturing

| | | |
|---|---|---|
| Hardness (shore A) - | 69 | 68 |
| according to rule NBR 7318 | | |
| Elongation (%) - | 110 | 289 |
| according to rule NBR 7462 | | |
| Tearing stress (Kgf/cm²) - | 69 | 82 |
| according to rule NBR 7462 | | |

Mechanical Properties
Vulcanization: t′90 at 185° C.; after maturing

| | | |
|---|---|---|
| Hardness (shore A) ⁽⁸⁾ - | 70 | 71 |
| according to rule NBR 6565 | | |
| Elongation (%) ⁽⁸⁾ - | 110 | 250 |
| according to rule NBR 6565 | | |
| Tearing stress (Kgf/cm²) ⁽⁸⁾ - | 79 | 85 |
| according to rule NBR 6565 | | |
| Permanent distortion to | 22 | 30 |
| compression (%) ⁽⁹⁾ - according to | | |
| rule NBR 10025 | | |
| Ozone Resistance ⁽¹⁰⁾ - | No slots | No slots |
| according to rule ASTM 1171 | | |

⁽⁸⁾ Fast maturing in incubator; exposition for 70 hours, at 70° C.
⁽⁹⁾ Exposition for 22 hours at 70° C.
⁽¹⁰⁾ Exposition for 70 hours at 40° C., 50 ppcm over mandrill.

In another aspect, the present invention refers to a manufacturing process of the formulation with stages suitable to the desired properties, as well as its extruded colored profile. The process of the present invention comprises the basic stages of:

(a) Mixing; and

(b) Extrusion and vulcanization.

### Process Mixing Stage

EPDM rubber, antioxidant, HDS precipitated silica, interface agent, coupling agent, 60% of the amount of process oil, for instance, paraffinic and desiccating are mixed in an internal mixer, for instance, a Banbury type or with rotating sigma bladders, for obtaining a mass.

When the temperature of the mass achieves about 140 to 190° C., preferably 150° C., the process of mixing must be kept for about 3 to 10 minutes. It may be important that the achieved temperature is high, preferably about 150° C., so that the free water presented in the silica evaporates during the process of mixing, and does not provoke the formation of bubbles inside the profile during the extrusion and vulcanization stage. Then, the rest of the ingredients, according to the formulation is added, for instance 40% of the amount of the oil process, non-reinforcing fillers (calcined kaolin, calcium carbonate), zinc oxide, stearic acid, and flow agent, to unload the homogenized paste.

It is necessary to add to the formulation an efficient desiccant like CaO in amounts superior to those commonly used in order to react with free water presented in silica, forming calcium hydroxide stable in temperatures of vulcanization and then avoiding the formation of bubbles inside the profile. The obtained mass is then placed between the cylinder rolls of an opening mixer by adding pigments, vulcanization accelerators and sulphur (responsible for the occurring of vulcanization process). The mass is totally homogenized.

### Extrusion and Vulcanization Stage

The profile is obtained by an extruder, usually a monoscrew. Immediately after its extrusion, the rubber profile is placed in a vehicle, for instance, a treadmill troller that enters in a warmed tunnel to vulcanize in a temperature of about 150° C. to 280° C., preferably between about 240 and 250, about 210° C. The speed of the treadmill roller is regulated in order to guarantee the rubber to be inside the tunnel for enough time to complete the vulcanization reaction.

It may be important to make the vulcanization reaction happen fast, as another way to minimize the bubbles formation caused by the free water present in the HDS precipitated silica. For this purpose, the dosages of the accelerators must be raised, and ZnO in bigger proportions than the ones used conventionally, must be added because zinc oxide is also favorable for a better thermal conductivity of the material and makes the vulcanization in the center of he profile to begin faster.

In a third aspect, the present invention refers to the use of the reinforced EPDM with high dissipating precipitated silica formulation as previously depicted, e.g. for use in producing a joining element and/or sealing part, particularly an extruded profile, useful in the industry, for instance, the building and automotive industry.

From the teachings mentioned herein, a person skilled in the art will know how to propose several equivalent embodiments not specifically mentioned, but that are included in the scope of the claims.

1-14. (canceled)

15. A method for he manufacturing of a reinforced ethylene-propylene-diene monomer (EPDM) rubber formulation, the method comprising:
mixing EPDM, an antioxidant, a precipitated silica, an interface agent, a coupling agent, a first portion of a process oil, and a desiccant in a mixer at a temperature of 140° C. to 190° C. to define a mixture, and keeping the mixture at the temperature for about 3 to 10 minutes;
adding a second portion of the process oil, non-reinforcing fillers including at least one of calcined kaolin and calcium carbonate, zinc oxide, stearic acid, and a flow agent, to form an homogeneous mass; and
putting the homogenous mass between mixer rollers, adding pigments, vulcanization accelerators and sulphur to define a formulation, and then homogenizing the formulation.

16. The method according to claim 15, wherein the mixing of the ingredients is performed in an ordered manner.

17. The method according to claim 15, wherein the temperature of the mixer reaches about 150° C.

18. The method according to claim 15, wherein the first portion of the process oil inserted comprises 60% of a total amount of process oil.

19. The method according to claim 18, wherein the second portion of the process oil comprises 40% of the total amount of process oil.

20. The method according to claim 15, wherein the desiccant comprises calcium oxide.

21. The method according to claim 15, wherein the precipitated silica includes up to 8% water content.

22. The method according to claim 15, wherein the precipitated silica has a D50 value of about 2.8 μm.

23. A precipitated silica reinforced epdm rubber formulation obtained by the method of claim 15.

24. A rubber seal comprising a precipitated silica reinforced epdm rubber formulation obtained by the method of claim 15.

25. A method for obtaining a reinforced rubber profile, the method comprising:
making a reinforced ethylene-propylene-diene (EPDM) rubber formulation including mixing EPDM, an antioxidant, a precipitated silica, an interface agent, a coupling agent, a first portion of a process oil, and a desiccant in a mixer at a temperature of 140° C. to 190° C. to defining a mixture, and keeping the mixture at the temperature for about 3 to 10 minutes,
adding a second portion of the process oil, non-reinforcing fillers including at least one of calcined kaolin and calcium carbonate, zinc oxide, stearic acid, and a flow agent, to form an homogeneous mass, and
putting the homogenous mass between mixer rollers, adding pigments, vulcanization accelerators and sulphur to define a formulation, and then homogenizing the formulation;
extruding the formulation in an extruder to define a profile; and
vulcanizing the profile in a warming tunnel in a temperature between about 150° C. to about 280° C.

26. The method according to claim 25, wherein the temperature of the warming tunnel is about 240° C. to about 250° C.

27. The method according to claim 25, wherein adding pigments comprises adding at least one coloring pigment; and wherein the profile comprises a colored profile.
